(19) United States
(12) Patent Application Publication
(10) Pub. No.: US 2018/0094659 A1
(43) Pub. Date: Apr. 5, 2018

(54) HELICAL COIL FASTENER AND METHOD

(71) Applicant: David Christie McHenry, JR., Stone Mountain, GA (US)

(72) Inventor: David Christie McHenry, JR., Stone Mountain, GA (US)

(21) Appl. No.: 15/719,721

(22) Filed: Sep. 29, 2017

Related U.S. Application Data
(60) Provisional application No. 62/495,964, filed on Sep. 30, 2016.

(51) Int. Cl. F16B 2/22

(52) U.S. Cl. CPC F16B 2/22

(57) ABSTRACT

A helical coil fastener and method for fastening objects is disclosed. The fastener comprises a stump and a rooting lashing. The rooting lashing comprises a first end and second end, defined by a plurality of helical coils. The first end of the rooting lashing is attached to an end of the stump, configured to receive a portion of the object forming a rooting eye at the connection between the rooting lashing and the stump. Further, the helical coils apart from the first helical coil of the rooting lashing is configured to wrap on the stump thereon. The fastener further comprises a trunk lashing attached to an end of the stump comprises a first end and second end, defined by a plurality of helical coils. The helical coils of the trunk lashing are configured to wrap on a portion of the object, thereby a user ensures fastening the object.

### CROSS REFERENCE TO RELATED APPLICATIONS

The present application claims priority from provisional application 62/495,964 filed Sep. 30, 2016.

### COPYRIGHT NOTICE

A portion of this patent document contains material which is subject to copyright protection. The copyright owner has no objection to the facsimile reproduction by anyone of the patent document or patent disclosure, as it appears in the Patent and Trademark Office patent files or records, but otherwise reserves all copyright rights whatsoever.

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM, LISTING COMPACT DISK APPENDIX

Not Applicable

### BACKGROUND OF THE INVENTION

### A. Technical Field

The present invention generally relates to a fastener. More specifically, this invention relates to a helical coil fastener configured to fasten wide variety of objects, for example, cords, keys, etc.

### B. Description of Related Art

Generally, lashing is a type of fastening technique, done by way of successive wrapping of wires or webbings to secure and fasten two or more items together in a rigid manner Variety of lashing strap and cord fasteners are available for removably tying down an object to a support or structure. Typically, these fasteners are configured to tension, in order to more securely tie the object to the support.

Existing fasteners include elastomeric straps, see for example U.S. Pat. No. 5,325,568 (Bruhm, 1994), elastomeric cords, see for example U.S. Pat. No. 6,014,794 (Mc Coy, 2000), flexible curled cords, see for example U.S. Pat. No. 5,515,580 (McHenry Jr., 1996) and coiled springs, see for example U.S. Pat. No. 1,519,854 (Lockwood, 1924).

Known fasteners also include devices having an elastic elongate member as well as a non-elastic elongate member. A variety of fastening implements or fasteners are known for fastening to a support, a load such as a package, or for fastening the lashing itself and thereby forming a loop. These fastening implements include hooks, hook and ring combinations, for example U.S. Pat. No. 4,569,108 (Schwab, 1986). While many of these fastening devices are attached to the ends of an elongate member, it is also known to employ fastening implements that can be positioned at substantially any point along an elongate fastening member, see for example U.S. Pat. No. 5,383,259 (McIntire, 1995). Generally, the fastening implements include rigid components for example metal or rigid plastic. Such rigid implements can damage the surface of an object that is secured by a tie-down. Also, these implements can damage the tie-down device, when the fastening implement is fastened to form a loop in the device.

Typically tie-down devices such as described above are provided in specific lengths, see for example U.S. Pat. No. 6,099,060 (Towers, 2000). But it is also known to employ fastening techniques that allow placement of one or more fasteners along substantially the entire length of the elongate member, thereby enabling a user to employ a selected portion of the elongate member.

Prior art fastening devices and techniques have thus resulted in a variety of useful solutions to common tie-down fastener problems. Further, the existing reusable fastener may be lost, if not conveniently attached to the portable object where it is used. However, there exists a need for improved fasteners that provide the capability to secure an object to a structure without utilizing fastening implements or components and the user of the device can employ either a portion or substantially the entire length of the fastening device.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The present invention relates to a helical coil fastener for fastening one or more objects such as cords, cables, keys or any supporting elements. In an embodiment, the fastener comprises a stump, and a rooting lashing. In one embodiment, the stump made of a flexible and resilient material, comprises a first end and a second end. In one embodiment, the rooting lashing made of a flexible and resilient material, comprises a first end and second end, and the rooting lashing is defined by a plurality of helical coils. In one embodiment, the first end of the rooting lashing is attached to an end of the stump. The first helical coil of the rooting lashing is configured to receive a portion of the object forming a rooting eye at the connection between the rooting lashing and the stump. In one embodiment, the helical coils apart from the first helical coil of the rooting lashing is configured to wrap on the stump thereon.

In one embodiment, the helical coil fastener further comprises diameter of a circumscribing circle of the cross section of an enclosed profile of the helical coil and an inner diameter of the helical coil. In some embodiments, the diameter of a circumscribing circle of the cross section of an enclosed profile of the helical coil is substantially larger than the inner diameter of the helical coil. In one embodiment, the second end of the stump is configured with a flanged trunk, flanged trunk incorporated with one or more holes for auxiliary mechanical attachment, an annular trunk, or a sleeved trunk. In one embodiment, the second end of the stump is attached with various trunk bodies. The second end of the stump is attached with a mirrored rooting lashing.

In another embodiment, the fastener comprises a stump, a rooting lashing and a trunk lashing. In one embodiment, the stump made of a flexible and resilient material, comprises a first end and a second end. In one embodiment, the rooting lashing made of a flexible and resilient material, comprises a first end and second end, and the rooting lashing is defined by a plurality of helical coils. In one embodiment, the first end of the rooting lashing is attached to an end of the stump. The first helical coil of the rooting lashing is configured to receive a portion of the object forming a rooting eye at the connection between the rooting lashing and the stump. In one embodiment, the helical coils apart from the first helical coil of the rooting lashing is configured to wrap on the stump thereon. In one embodiment, the trunk lashing made of a flexible and resilient material, having a first end and second end, defined by a plurality of helical coils. The first end of the trunk lashing is attached to an end of the stump. In one embodiment, the plurality of helical coils in the first end of the trunk lashing is configured to wrap on a portion of the object extending from the stump towards the second end of the trunk lashing, thereby a user ensures fastening a desired portion of the object.

In one embodiment of the present invention, the stump is defined by an arcuate stump or a tapered stump. In one embodiment, the helical coil fastener further comprises a dorsal face of the helical coil, and a ventral face of the helical coil. The ventral face in the second end of the trunk lashing includes a clasper for firm fastening a portion of the object. In some embodiments, the clasper is further configured with a treaded surface for firm gripping on a portion of the object. In one embodiment, the dorsal face in the second end of the trunk lashing is extended by a dorsal branch to connect a helve. The helve is configured to fasten or unfasten the desired portion of the object. In some embodiments, the helve is flat shaped structure or leaf shaped structure. In various embodiments, the flexible and resilient material is selected from any elastomeric materials, but not limited to thermoplastic materials.

The present invention relates to a method of fastening one or more objects such as such as cords, cables, keys or any supporting elements using a helical coil fastener is disclosed. In one embodiment, the method comprises the step of a) providing a helical coil fastener, the helical coil fastener comprises a stump having a first end and a second end, and a rooting lashing made of a flexible and resilient material, having a first end and second end, defined by a plurality of helical coils, wherein the end of the rooting lashing is attached to an end of the stump, b) receiving a portion of the object by the first helical coil of the rooting lashing forming a rooting eye at the connection between the rooting lashing and the stump, c) wrapping the helical coils apart from the first helical coil on the stump, thereby an user ensures fastening a desired portion of the object. In various embodiments, the flexible and resilient material is selected from any elastomeric materials, but not limited to thermoplastic materials.

In another embodiment, the method also includes helical coil fastener with a trunk lashing along with said stump and rooting lashing. The trunk lashing made of a flexible and resilient material, comprises a first end and second end, defined by a plurality of helical coils. The first end of the trunk lashing is attached to an end of the stump. In one embodiment, the plurality of helical coils in the first end of the trunk lashing is configured to wrap on a portion of the object extending from the stump towards the second end of the trunk lashing, thereby the user further ensures fastening a desired portion of the object.

In another embodiment of the method, the desired portion of the objects is fastened by inter-locking the plurality of the helical coil fastener. In one embodiment, the method further comprises a dorsal face of the helical coil, and a ventral face of the helical coil, where the ventral face in the second end of the trunk lashing includes a clasper for firm fastening a portion of the object. In another embodiment, the dorsal face in the second end of the trunk lashing is extended by a dorsal branch to connect a helve, wherein the helve is configured to fasten or unfasten the desired portion of the object.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1A is a front view of a helical coil fastener for fastening one or more objects, in accordance to one embodiment;

FIG. 1B is a sectional view taken generally on the line 1B-1B of FIG. 1A;

FIG. 1C is a perspective view of the helical coil fastener for fastening one or more objects of FIG. 1A showing the fastener disposed with the rooting eye tied in the closed position;

FIG. 2 is a perspective view of a helical coil fastener in accordance to another embodiment with a flanged trunk;

FIG. 3 is a perspective view of a helical coil fastener in accordance to another embodiment with an annular trunk;

FIG. 4 is a perspective view of a helical coil fastener in accordance to another embodiment having a flanged trunk with holes for auxiliary mechanical attachment;

FIG. 5 is a perspective view of a helical coil fastener in accordance to another embodiment having a sleeved trunk;

FIG. 6 is a perspective view of a helical coil fastener in accordance to another embodiment where the trunk is embodied as a mirroring of the rooting lashing at an end of the stump;

FIG. 7A is a perspective view of a helical coil fastener for fastening one or more objects, in accordance to another embodiment;

FIG. 7B is a front view of the helical coil fastener of FIG. 7A;

FIG. 7C is a sectional view taken generally on the line 7C-7C of FIG. 7B;

FIG. 7D is a perspective view of the helical coil fastener for fastening one or more objects of FIG. 7A showing the fastener disposed with the rooting eye tied in the closed position;

FIG. 7E is a perspective view of the helical coil fastener for fastening one or more objects of FIG. 7A showing the fastener disposed with the rooting eye rooted to a strand;

FIG. 8A is a perspective view of a helical coil fastener for fastening one or more objects, in accordance to another embodiment;

FIG. 8B is a perspective view of a helical coil fastener for fastening one or more objects of FIG. 8A showing the fastener disposed with the rooting eye tied in the closed position;

FIG. 8C is a perspective view of a helical coil fastener for fastening one or more objects of FIG. 8A showing the fastener with the rooting eye rooted to a strand;

FIG. 8D is a perspective view of a helical coil fastener for fastening one or more objects of FIG. 8A showing the fastener rooted to one strand of a sheaf and the lashing strands bound around the sheaf;

FIG. 8E is a perspective view of the helical coil fastener of FIG. 8A showing the fastener rooted to one strand of a sheaf and bound around the sheaf and showing the dorsal branch abutting a strand;

FIG. 8F is a perspective view of the helical coil fastener for fastening one or more objects of FIG. 8A showing the fastener rooted to a tomato cage and the lashing coils supporting the body of a plant via prehensile clasping;

FIG. 8G is a perspective view of the helical coil fastener for fastening one or more objects of FIG. 8A showing the fastener rooted to a strand by an alternate disposition of the rooting helical coil;

FIG. 8H is a perspective view of the helical coil fastener for fastening one or more objects of FIG. 8A showing the fastener rooted to a portable object and the lashing coils connected to a fixed object by way of prehensile clasping;

FIG. 9A is a perspective view of a helical coil fastener with flat shaped structure of helve, in accordance to another embodiment;

FIG. 9B is a detail view of the helical coil fastener of FIG. 9A showing one possible embodiment of a tread surface on the ventral face of clasper;

FIG. 10 illustrates a method of fastening one or more objects using a helical coil fastener, in accordance to another embodiment.

LIST OF REFERENCE NUMERALS

| | |
|---|---|
| 100 helical coil fastener with | 200 helical coil fastener with 110, 114 |
| 110 and 114 | and 116 |
| 110 rooting lashing | 230 objects or stands |
| 114 stump | 116 trunk lashing |
| 114a first end of stump | 112 rooting eye |
| 114b second end of stump | BØ diameter of circumscribing circle |
| 110a first end of rooting lashing | CØ inside diameter of the rooting |
| | lashing |
| 110b second end | 116a first end of trunk lashing |
| 122 helical coils | 116b second end of trunk lashing |
| 122a first helical coil | 118 dorsal face |
| 110′ mirrored rooting lashing | 120 ventral face |
| 122 helical coils | 122a first helical coil |
| 224 dorsal branch | 226 helve |
| 228 clasper | 232 sheaf |
| 236 tomato cage | 344 tread surface |

### DETAILED DESCRIPTION OF THE INVENTION

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

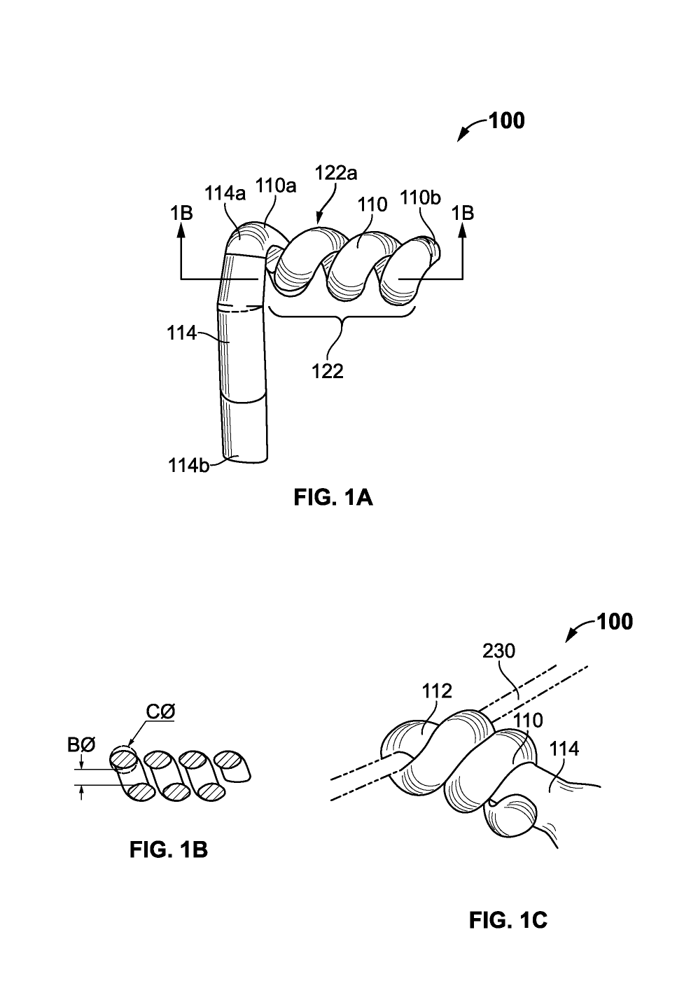

The present invention discloses a helical coil fastener 100 for fastening one or more objects or stands 230 such as cords, cables, keys or any supporting elements. Referring to FIG. 1A, a front view of a helical coil fastener 100 for fastening one or more objects 230, in accordance to one embodiment. In an embodiment, the fastener 100 comprises a stump 114, and a rooting lashing 110. In one embodiment, the stump 114 made of a flexible and resilient material, comprises a first end 114a and a second end 112b. In one embodiment, the rooting lashing 110 made of a flexible and resilient material, comprises a first end 110a and second end 110b, and the rooting lashing 110 is defined by a plurality of helical coils 122. In one embodiment, the first end 110a of the rooting lashing 110 is attached to an end of the stump 114. The first helical coil 122a of the rooting lashing 110 is configured to receive a portion of the object 230 forming a rooting eye 112 at the connection between the rooting lashing 110 and the stump 114. In one embodiment, the helical coils 122 apart from the first helical coil 122a of the rooting lashing 110 is configured to wrap on the stump 114 thereon. In some embodiments, the stump 114 is a tapered stump, thereby said tapered stump causes the rooting lashing 110 to be urged towards the rooting eye 112 keeping it tight.

Referring to FIG. 1B, a sectional view taken generally on the line 1B-1B of FIG. 1A is disclosed. Referring to FIGS. 1A and 1B, the diameter of circumscribing circle BØ represents a value for the diameter of a circle that will circumscribe the rooting lashing 110 cross sectional profile at the connection to the stump 114. Inside diameter CØ of the rooting lashing 110 is the full clearance dimension down the center of the rooting lashing 110. In one embodiment, the helical coil fastener 100 further comprises diameter of a circumscribing circle of the cross section of an enclosed profile of the helical coil 122 and an inner diameter of the helical coil 122. In some embodiments, the diameter of a circumscribing circle of the cross section of an enclosed profile of the helical coil 122 is substantially larger than the inner diameter of the helical coil 122.

A method of using the helical coil fastener 100 of FIG. 1A for fastening one or more objects is shown in FIG. 1C. In one embodiment, the first helical coil 122a of the rooting lashing 110 is configured to receive a portion of the object 230 forming a rooting eye 112 at the connection between the rooting lashing 110 and the stump 114. The rooting eye 112 is configured to root the fastener 100 to a variety of objects 230. In one embodiment, the helical coils 122 apart from the first helical coil 122a of the rooting lashing 110 is configured to wrap on the stump 114.

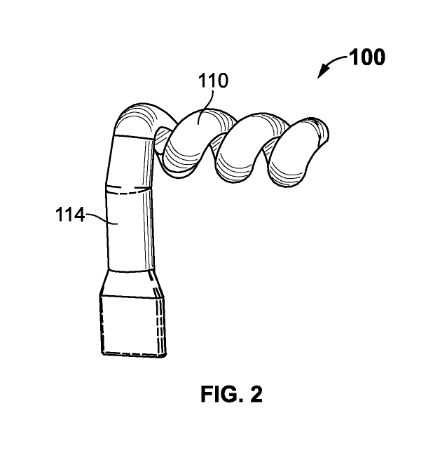

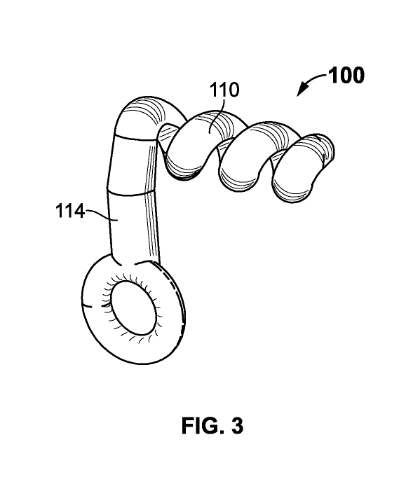

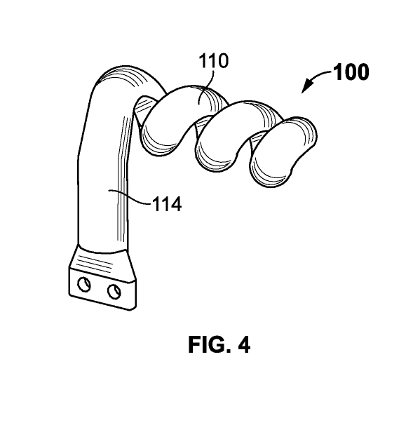

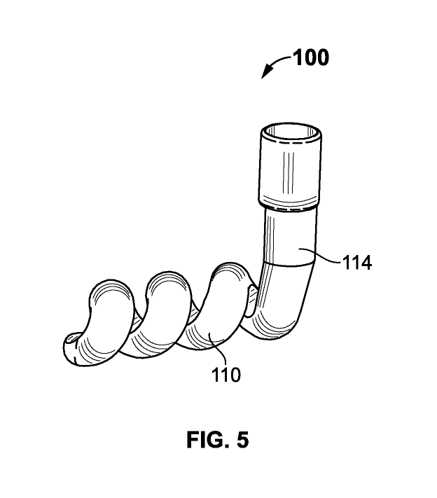

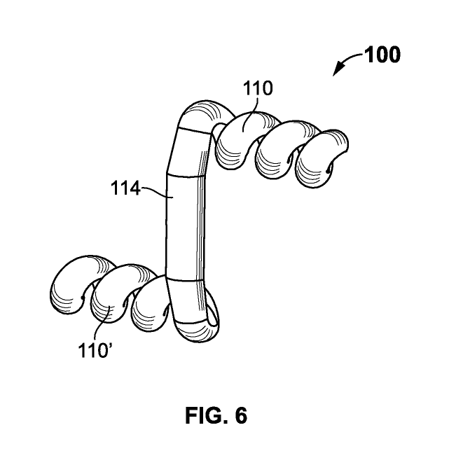

In various embodiments of above described FIG. 1A, the second end 112b of the stump 114 is configured with various configuration of trunk bodies. Referring to FIG. 2, a perspective view of a helical coil fastener 100 in accordance to another embodiment with a flanged trunk, is disclosed. In some embodiments, the flat front face of the flanged trunk is used as a marker or tag. FIG. 3 illustrates a helical coil fastener in accordance to another embodiment with an annular trunk. FIG. 4 illustrates a helical coil fastener in accordance to another embodiment comprises a flanged trunk with holes for auxiliary mechanical attachment. FIG. 5 illustrates a helical coil fastener in accordance to another embodiment comprises a sleeved trunk. FIG. 6 is a perspective view of a helical coil fastener in accordance to another embodiment where the trunk is embodied as a mirroring of the rooting lashing at an end of the stump. The second end of the stump is attached with a mirrored rooting lashing 110′. In various embodiments, the flexible and resilient material is selected from any elastomeric materials, but not limited to thermoplastic materials.

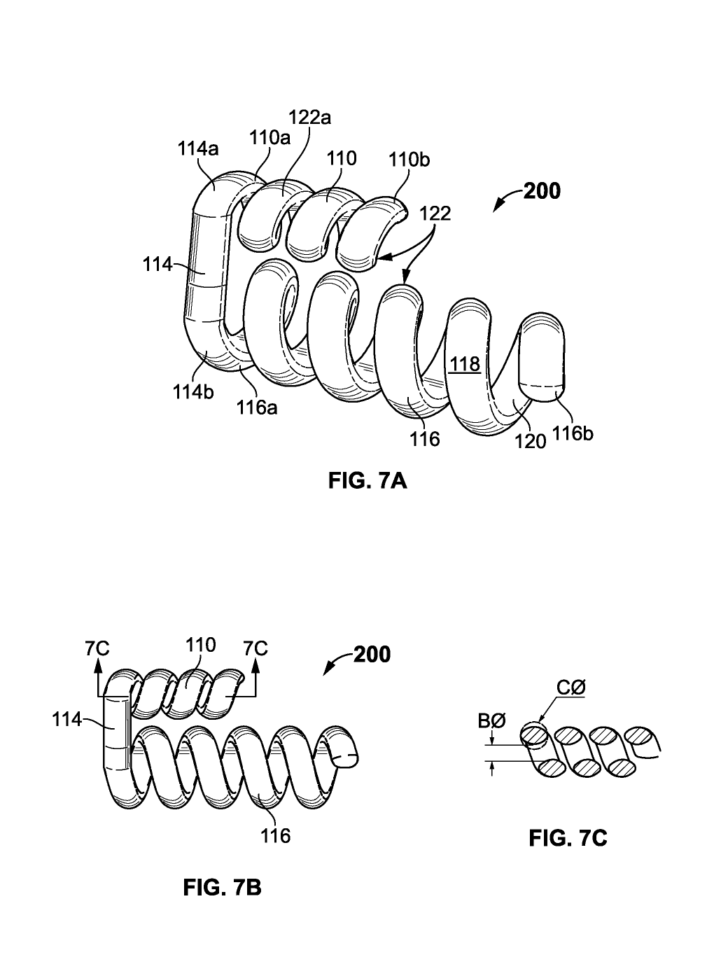

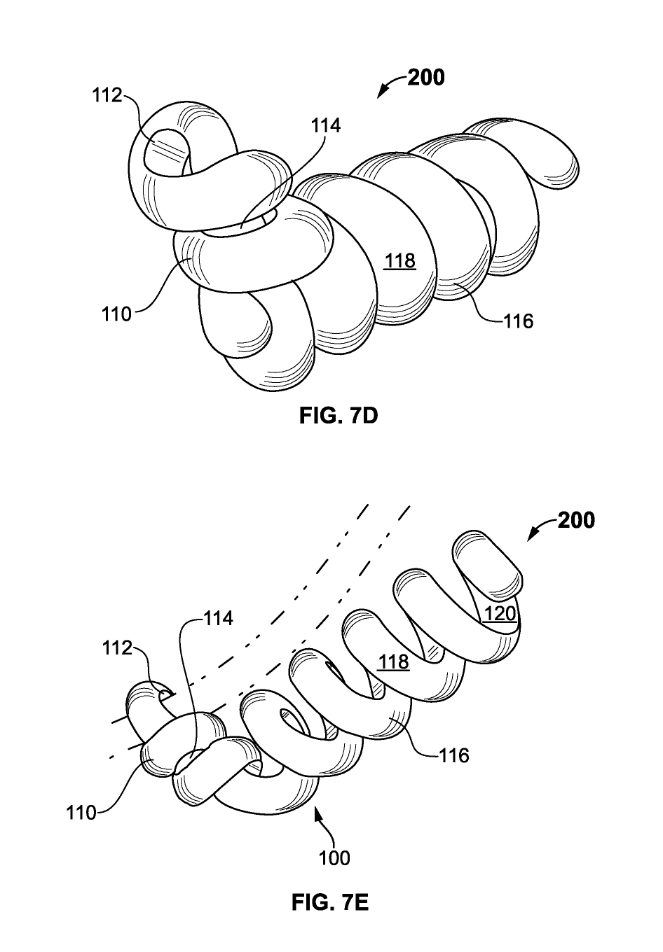

FIG. 7A is a perspective view of a helical coil fastener 200 for fastening one or more objects 230, in accordance to another embodiment. The present invention also relates to a helical coil fastener 200 for fastening one or more objects 230 such as cords, cables, keys or any supporting elements, comprises a stump 114, a rooting lashing 110 and a trunk lashing 116. In one embodiment, the stump 114 made of a flexible and resilient material, comprises a first end 114a and a second end 112b. In one embodiment, the rooting lashing 110 made of a flexible and resilient material, comprises a first end 110a and second end 110b, and the rooting lashing 110 is defined by a plurality of helical coils 122. In one embodiment, the first end 110a of the rooting lashing 110 is attached to an end of the stump 114. The first helical coil 122a of the rooting lashing 110 is configured to receive a portion of the object 230 forming a rooting eye 112 at the connection between the rooting lashing 110 and the stump 114.

In one embodiment, the helical coils 122 apart from the first helical coil 122a of the rooting lashing 110 is configured to wrap on the stump 114 thereon. In one embodiment, the trunk lashing 116 made of a flexible and resilient material, comprises a first end 116a and second end 116b, defined by a plurality of helical coils 122. The first end of the trunk lashing is attached to an end of the stump. In one embodiment, the plurality of helical coils 122 in the first end 116a of the trunk lashing 116 is configured to wrap on a portion of the object 230 extending from the stump 114 towards the second end 116b of the trunk lashing 116, thereby a user ensures fastening a desired portion of the object 230. In one embodiment, the helical coil fastener 200 further comprises a dorsal face 118 of the helical coil 122, and a ventral face 120 of the helical coil 122.

In one embodiment of the present invention, the stump 114 is defined by an arcuate stump, or a tapered stump. In some embodiments, the stump 114 is a tapered stump, thereby said tapered stump causes the rooting lashing 110 to be urged towards the rooting eye 112 keeping it tight. The arcuate stump comprises an arcuate curve, which is beneficial on implementing embodiments with trunk lashing 116. This is because, the arcuate curve tends in the direction to the configuration of the trunk lashing 116.

FIG. 7B is a front view of the helical coil fastener of FIG. 7A. In one embodiment, the rooting lashing 110 is generally defined as a body created by the sweep of a closed two-dimensional curved profile comprises no concavities or flats. The profile is swept normal to a substantially helical three-dimensional curve. The stump 114 extends in generally straight path beginning at one end of the helical curve defining the rooting lashing 110, the path lying generally tangent to a circle circumscribing the curve and the circle is substantially perpendicular to the axis of the helix. The stump 114 is slightly longer than the sum of the outside diameters of the coils of the rooting lashing 110 and the trunk lashing 116 divided by two.

In one embodiment, the trunk lashing 116 connect to the opposite end of the stump 114 from the end where the rooting lashing 112 connect. The trunk lashing 116 is generally defined by a body created by the sweep of a closed two-dimensional curved profile comprises no concavities or flats. The profile is swept normal to a substantially helical three-dimensional curve. In some embodiments, the direction of the pitch of the substantially helical curve defining the trunk lashing 116 is opposite to the direction of the helical curve of the rooting lashing 110. The orientation of the stump 114 and the trunk lashing 116 is such that the stump 114 lies in a path generally tangent to a circle circumscribing the helical curve of the trunk lashing 116 and the circle is substantially perpendicular to the axis of the helical curve of the trunk lashing 116. Therefore, of necessity the helical axes of the rooting lashing 112 and trunk lashing 116 lie generally in the same plane and side by side.

FIG. 7C is a sectional view taken generally on the line 7C-7C of FIG. 7B. To further define the helical coil fastener 200 shown in FIG. 7A, FIG. 7C is included to show a portion of the helical coil fastener 200. The diameter of circumscribing circle BØ represents a value for the diameter of a circle that will circumscribe the rooting lashing 110 cross sectional profile at the connection to the stump 114. The rooting lashing 110 inside diameter CØ is the full clearance dimension down the center of the rooting lashing 110. A method of using the helical coil fastener 200 of FIG. 7A for fastening one or more objects is shown in FIG. 7D and FIG. 7E. In FIG. 7D, the fastener 200 is disposed with the rooting eye 112 tied in closed position, where the rooting lashing 110 lashed to the stump 114. The rooting eye 112 is configured to root the fastener 200 to a variety of objects 230.

In FIG. 7E, the fastener 200 is shown rooted to an object or strand 230. This is done by slipping or receiving the strand 230 in between the first helical coil of the rooting lashing 110 on the side away from the stump 114. Then, tucking the strand 230 down into the first helical coil of the rooting lashing 110, where the stump 114 and rooting lashing 110 connect. Then, folding the rooting lashing 114 over the strand 230 and lashing the entirety of the rooting lashing 110 around the stump 114. In some embodiments, the user may adjust the sharpness and tightness of the fold of the rooting lashing 110 over the strand 230. Adjustment helps in setting the rooting lashing 110, and its geometry set forth is intentionally directed to provide a fit for narrow strands 230. The rooting lashing, when folded sharply forces the rooting eye to close to a diameter smaller than CØ. If rooting to a smaller strand 230, the first full lashing turn of the rooting lashing 110 could be pushed up to effectively close the rooting eye 110 opening to zero. Alternatively, for large strands 230, the fold is relaxed and rooting could be made around very large strands 230 such as a boat's hand rail.

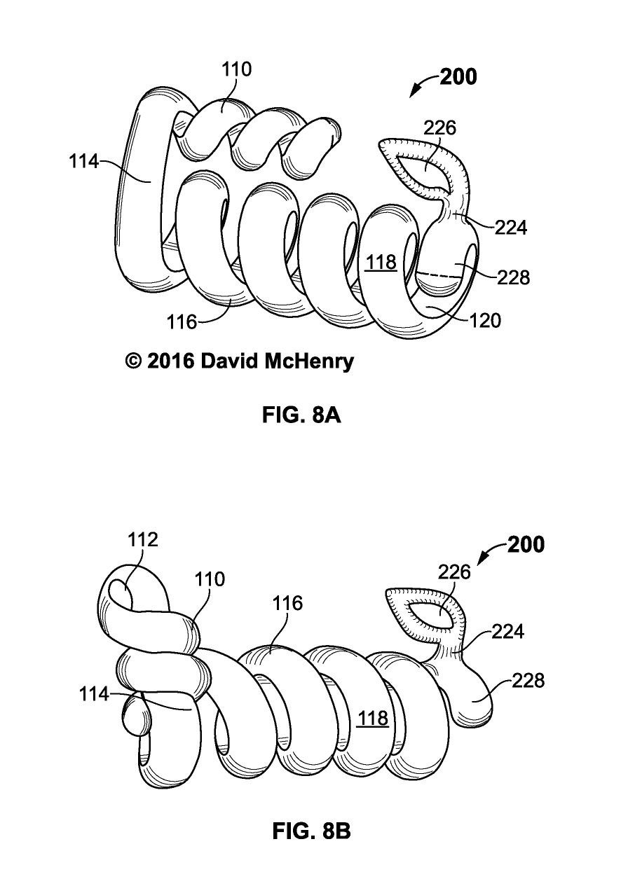

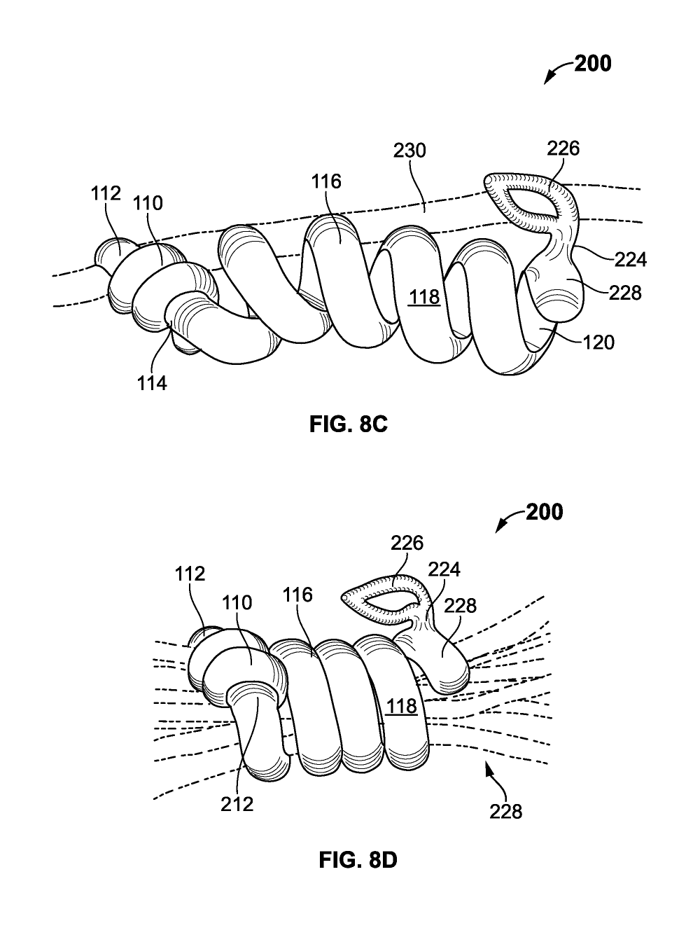

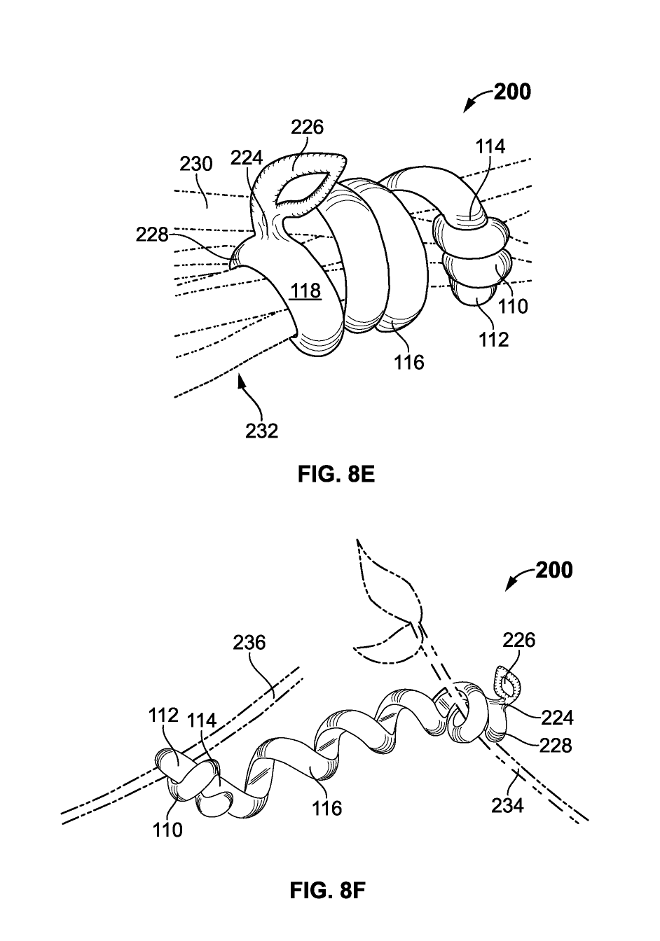

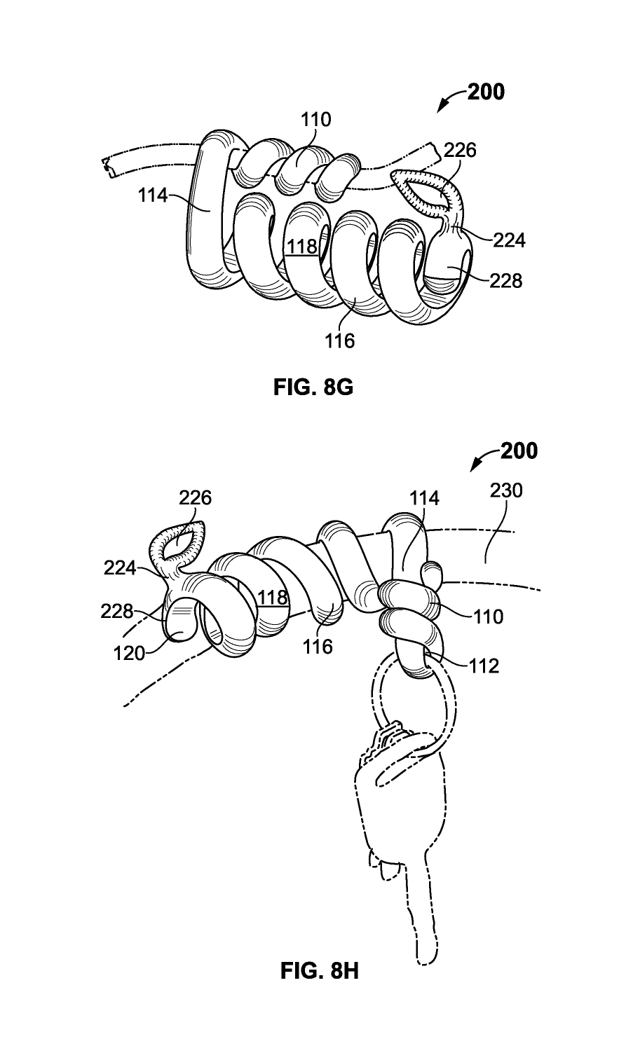

FIG. 8A is a perspective view of a helical coil fastener 200 for fastening one or more objects 230 with a helve 226, in accordance to another embodiment. In one embodiment, the dorsal face 118 in the second end of the trunk lashing 116 is extended by a dorsal branch 224 to connect a helve 226. The helve 226 is configured to fasten or unfasten the desired portion of the object 230. Referring to FIG. 8B, the fastener 200 disposed with the rooting eye 112 tied in the closed position is shown. The method of forming the rooting eye 112 is similar to the above described embodiments of FIG. 7A-FIG. 7E. Referring to FIG. 8C, the fastener 200 with the rooting eye 112 rooted to a strand 230, similar to the above described embodiments of FIG. 7A-FIG. 7E with helve 226. Referring to FIG. 8D, the fastener 200 is rooted to one strand of a sheaf 232 and the lashing strands bound around the sheaf 232. Henceforth, the fastener 200 proves that it could fasten any size of the objects 230.

Referring to FIG. 8E, the fastener 200 is rooted to one strand of a sheaf 232 and bound around the sheaf 232. Further, the dorsal branch 224 abutting a strand, which provides firm lock around the strands of the sheaf 232. In another embodiment, the fastener 200 rooted to a tomato cage 236 and the lashing helical coil supporting the body of a plant 234 via prehensile clasping, shown in FIG. 8F. The fastener 200 is rooted to a strand 230 by an alternate disposition of helical coil of the rooting lashing 110, is shown in FIG. 8G. The entire helical coils of the rooting lashing 110 is configured to fasten the strand 230.

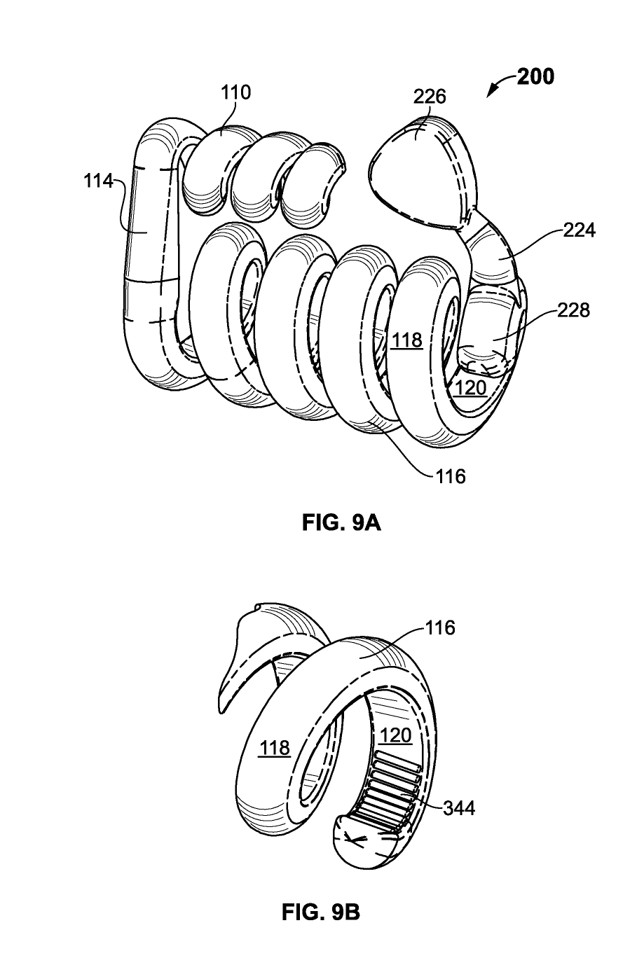

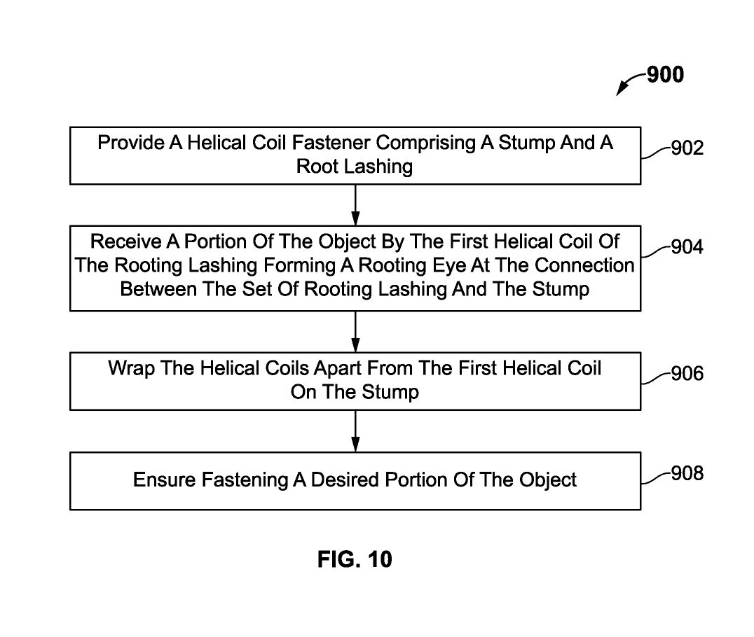

In another embodiment, the fastener 200 is used to fasten any kind of portable objects, for examples, key chain for a key, etc. The fastener 200 rooted to a portable object and the lashing helical coils connected to a fixed object by way of prehensile clasping, as illustrated in FIG. 8H. In some embodiments, the helve 226 is configured with different shape and structures. The leaf shaped structure of helve 226 is illustrated in FIG. 8A-8H. In another embodiment, the helical coil fastener 200 with flat shaped structure of helve 226 is illustrated in FIG. 9A. Referring to FIG. 9B, a detail view of the helical coil fastener of FIG. 9A showing one possible embodiment of a tread surface 344 on the ventral face 120 of clasper 228. The ventral face 120 in the second end 116b of the trunk lashing includes a clasper 228 for firm fastening a portion of the object 230. In some embodiments, the clasper 228 is further configured with a treaded surface 344 for firm gripping on a portion of the object 230.

The present invention relates to a method 900 of fastening one or more objects such as such as cords, cables, keys or any supporting elements using a helical coil fastener (100 & 200) shown in FIG. 1A-7E, is disclosed. In step 902, the method 900 comprises providing a helical coil fastener 200 for fastening one or more objects 230 such as cords, cables, keys or any supporting elements, comprises a stump 114, a rooting lashing 110. In one embodiment, the stump 114 made of a flexible and resilient material, comprises a first end 114a and a second end 112b. In one embodiment, the rooting lashing 110 made of a flexible and resilient material, comprises a first end 110a and second end 110b, and the rooting lashing 110 is defined by a plurality of helical coils 122. In one embodiment, the first end 110a of the rooting lashing 110 is attached to an end of the stump 114. The first helical coil 122a of the rooting lashing 110 is configured to receive a portion of the object 230 forming a rooting eye 112 at the connection between the rooting lashing 110 and the stump 114. In one embodiment, the helical coils 122 apart from the first helical coil 122a of the rooting lashing 110 is configured to wrap on the stump 114 thereon. In one embodiment, the helical coil fastener 200 further comprises a dorsal face 118 of the helical coil 122, and a ventral face 120 of the helical coil 122. In various embodiments, the flexible and resilient material is selected from any elastomeric materials, but not limited to thermoplastic materials.

In step 904, the method 900 comprises receiving a portion of the object 230 by the first helical coil of the rooting lashing 110 forming a rooting eye 112 at the connection between the rooting lashing 110 and the stump 114. In step 906, the method 900 comprises, wrapping the helical coils 122 apart from the first helical coil 122a on the stump 114. Finally, in step 908, the user ensures fastening a desired portion of the object 230 using said helical coil fastener (100 & 200).

In another embodiment, the method 900 also includes helical coil fastener with a trunk lashing 116 along with said stump 114 and rooting lashing 110. The trunk lashing 116 made of a flexible and resilient material, comprises a first end 116a and second end 116b, defined by a plurality of helical coils 122. The first end 116a of the trunk lashing 116 is attached to an end of the stump 114. In one embodiment, the plurality of helical coils 122 in the first end 116a of the trunk lashing 116 is configured to wrap on a portion of the object 230 extending from the stump 114 towards the second end 116b of the trunk lashing 116, thereby the user further ensures fastening a desired portion of the object.

In another embodiment of the method 900, the desired portion of the objects 230 is fastened by inter-locking the plurality of the helical coil fastener (100 & 200). In one embodiment, the method 900 further comprises a dorsal face 118 of the helical coil, and a ventral face 120 of the helical coil, where the ventral face 120 in the second end of the trunk lashing 116 includes a clasper 228 for firm fastening a portion of the object 230. In another embodiment, the dorsal face 118 in the second end of the trunk lashing 116 is extended by a dorsal branch 224 to connect a helve 226, wherein the helve 226 is configured to fasten or unfasten the desired portion of the object 230. In various embodiments, the flexible and resilient material is selected from one or more elastomeric materials, but not limited to thermoplastic materials.

Various embodiments of the helical coil fasteners (100 & 200) provides a more versatile, effective, longer lasting, more compact, clean and sanitary, self-adjusting and economical device. The fastener (100 & 200) further provides a gentle restraint, appropriate to the task. Such gentle unprecedented versatility and capacity for rooting to other portable or fixed objects. The fastener (100 & 200) adapts easily to wide range of sizes of object. The fastener (100 & 200) could be used as a valued personal accessory. The articles of manufacture shown and described in this application used as personal accessories, for example, a keychain, etc. The rooting eye 112 makes an exceptionally nice way of connecting to a keychain. It is comfortable in the user's hand and makes the keys easy to view and feel out. In keychains, the fastener (100 & 200) have the ability to hang one or more objects, which includes hanging from a door knob, the arm of a chair, a hand or boat rail. If an elastomer is the selected material for the fasteners (100 & 200), the keychain will be held with a secure grip, and avoid the chance of slippage. Further, with at least one embodiment of the fastener (100 & 200) employing lashings rooted to this loose end, the end with the strand like objects is conveniently secured, and released. According to the present invention, the fastener (100 & 200) is made from a variety of materials. A moderately flexible and resilient material is required. This will provide an article of single size fastener (100 & 200), capable of fastening around a wide range of object sizes. Many modern thermoplastics, for example, polypropylene or polyethylene could be utilized.

Further, the fasteners (100 & 200) are made of good thermoplastic elastomers with injection molded parts, with a compression set of 20-30%. The fasteners (100 & 200) are made of thermoplastic and thermoset polyurethane in range 50A to 85A shore hardness, with a compression set of about 25%. Further, the fastener (100 & 200) made of highly elastic material are accurately proportioned, so that the elongate member has sufficient large cross section. Additionally, it exhibits a negligible amount of stretch in the directional axis of the elongate member. The effective elastic opening and closing of the lashings diameter is incorporated with desired configuration, which contributes to gripping and holding of the bound object by the lashings.

The foregoing examples have been provided merely for the purpose of explanation and are in no way to be construed as limiting of the present concept disclosed herein. While the concept has been described with reference to various embodiments, it is understood that the words, which have been used herein, are words of description and illustration, rather than words of limitation. Further, although the concept has been described herein with reference to particular means, materials, and embodiments, the concept is not intended to be limited to the particulars disclosed herein; rather, the concept extends to all functionally equivalent structures, methods and uses, such as are within the scope of the appended claims. Those skilled in the art, having the benefit of the teachings of this specification, may affect numerous modifications thereto and changes may be made without departing from the scope and spirit of the concept in its aspects.

What is claimed is:

1. A helical coil fastener for fastening an object, the fastener comprising:
a stump made of a flexible and resilient material, having a first end and a second end;
a rooting lashing made of a flexible and resilient material, having a first end and second end, defined by a plurality of helical coils, wherein the first end of the rooting lashing is attached to an end of the stump, wherein the first helical coil of the rooting lashing is configured to receive a portion of the object forming a rooting eye at the connection between the rooting lashing and the stump, and the helical coils apart from the first helical coil is configured to wrap on the stump thereon.

2. The helical coil fastener of claim 1, further comprising diameter of a circumscribing circle of the cross section of an enclosed profile of the helical coil and an inner diameter of the helical coil, wherein the diameter of a circumscribing circle of the cross section of an enclosed profile of the helical coil is substantially larger than the inner diameter of the helical coil.

3. The helical coil fastener of claim 1, wherein the second end of the stump is configured with a flanged trunk.

4. The helical coil fastener of claim 1, wherein the second end of the stump is configured with the flanged trunk incorporated with one or more holes for auxiliary mechanical attachment.

5. The helical coil fastener of claim 1, wherein the second end of the stump is configured with an annular trunk.

6. The helical coil fastener of claim 1, wherein the second end of the stump is configured with a sleeved trunk.

7. The helical coil fastener of claim 1, wherein the second end of the stump is attached with a mirrored rooting lashing.

8. The helical coil fastener of claim 1, wherein the stump is a tapered stump, thereby said tapered stump causes the rooting lashing to be urged towards the rooting eye keeping it tight.

9. A helical coil fastener for fastening an object, the fastener comprising:
a stump made of a flexible and resilient material, having a first end and a second end;
a rooting lashing made of a flexible and resilient material, having a first end and second end, defined by a plurality of helical coils, wherein the first end of the rooting lashing is attached to an end of the stump, wherein the first helical coil of the rooting lashing is configured to receive a portion of the object forming a rooting eye at the connection between the rooting lashing and the stump, and the helical coils apart from the first helical coil is configured to wrap on the stump thereon, and
a trunk lashing made of a flexible and resilient material, having a first end and second end, defined by a plurality of helical coils, wherein the first end of the trunk lashing is attached to an end of the stump, wherein the plurality of helical coils in the first end of the trunk lashing is configured to wrap on a portion of the object extending from the stump towards the second end of the trunk lashing, thereby a user ensures fastening a desired portion of the object.

10. The helical coil fastener of claim 9, wherein the stump is an arcuate or a tapered stump.

11. The helical coil fastener of claim 9, further comprises a dorsal face of the helical coil, and a ventral face of the helical coil, wherein the ventral face in the second end of the trunk lashing includes a clasper for firm fastening a portion of the object.

12. The helical coil fastener of claim 11, wherein the clasper is further configured with a treaded surface for firm gripping on a portion of the object.

13. The helical coil fastener of claim 11, wherein the dorsal face in the second end of the trunk lashing is extended by a dorsal branch to connect a helve.

14. The helical coil fastener of claim 13, wherein the helve is configured to fasten or unfasten the desired portion of the object.

15. The helical coil fastener of claim 13, wherein the helve is flat shaped structure or leaf shaped structure.

16. The helical coil fastener of claim 9, further comprising diameter of a circumscribing circle of the cross section of an enclosed profile of the helical coil and an inner diameter of the helical coil, wherein the diameter of a circumscribing circle of the cross section of an enclosed profile of the helical coil is substantially larger than the inner diameter of the helical coil.

17. A method of fastening an object, the method comprising the step of:
providing a helical coil fastener, wherein the helical coil fastener comprising:
a stump made of a flexible and resilient material, having a first end and a second end, and
a rooting lashing made of a flexible and resilient material, having a first end and second end, defined by a plurality of helical coils, wherein the end of the rooting lashing is attached to an end of the stump,
receiving a portion of the object by the first helical coil of the rooting lashing forming a rooting eye at the connection between the rooting lashing and the stump,
wrapping the helical coils apart from the first helical coil on the stump, thereby a user ensures fastening a desired portion of the object.

18. The method of claim 17, further comprises a trunk lashing made of a flexible and resilient material, having a first end and second end, defined by a plurality of helical coils, wherein the first end of the trunk lashing is attached to an end of the stump,

19. The method of claim 18, further comprises a step of wrapping a portion of the object by the plurality of helical coils in the first end of the trunk lashing extending from the stump towards the second end of the trunk lashing, thereby a user ensures fastening a desired portion of the object.

20. The method of claim 17, wherein the desired portion of one or more objects is fastened by inter-locking the plurality of the helical coil fastener.
